(19) United States
(12) Patent Application Publication
(10) Pub. No.: US 2008/0037427 A1
(43) Pub. Date: Feb. 14, 2008

(54) Estimating bandwidth

(76) Inventor: Alexander A. Kist, Toowoomba (AU)

Correspondence Address: DILWORTH & BARRESE, LLP, 333 EARLE OVINGTON BLVD., SUITE 702, UNIONDALE, NY, 11553, US

(21) Appl. No.: 11/805,944

(22) Filed: May 24, 2007

(30) Foreign Application Priority Data
May 24, 2006 (AU) 2006-902805

(51) Int. Cl. H04L 12/26

(52) U.S. Cl. 370/235

(57) ABSTRACT

The present invention resides in a method of transmitting data packets between a first node coupled to be in communication with a first network and a second node coupled to be in communication with a second network, the first network and the second network coupled to be in communication with a plurality of network interfaces. The method includes measuring a forward data flow rate and a reverse data flow rate between the first node and the second node, determining an aggregate data flow rate based on the forward flow rate and the reverse flow rate, and assigning data flow to one or more of the network interfaces based on an available bandwidth of each network interface and the aggregate data flow rate.

### FIELD OF THE INVENTION

The present invention relates to a method for estimating bandwidth available on network interfaces. In particular, although not exclusively, the invention relates to estimating available bandwidth on network interfaces and optimising route for data packets through the network interfaces.

### DESCRIPTION OF THE PRIOR ART

A large number of private networks are owned by companies, organisations or individuals. These private networks have at least one interface connecting the private network to the Internet, with many private networks having more than one interface.

Where one interface connects a private network to the internet, all incoming and outgoing data packets communicated from a host on the private network to an external host on the Internet must pass through the one interface. Where multiple interfaces exist, the private network must designate an interface for all incoming and outgoing data packets transmitted externally.

One approach used where multiple interfaces exist is to transmit via one default interface, while the remaining interfaces are only used in the event of the default interface being incapable of sending additional data packets (i.e. an overflow scenario), or in the event the default interface fails (i.e. a failover scenario).

This approach fails to optimise the full potential of multiple interfaces. As a person skilled in the art can appreciate, optimisation for a multiple interface arrangement can be in terms of connection quality, even distribution of traffic and/or minimising costs associated with using different interfaces.

Other approaches include estimating a bandwidth available on each interface and routing data packets accordingly. One such approach is achieved by analysing the amount of data packets being sent out in a particular data flow. By looking at data packets travelling from the same source to the same destination, a prediction of the continued size of the flow is made, and the available bandwidth of the external interface on which that data flow is travelling through is updated accordingly. In this way, a prediction may be made as to the amount of traffic that is being and will, in the near future, be sent through a particular interface, and with this information routing decisions may be made.

While performing such predictions provides for a more accurate estimation of used and available bandwidth than a mere consideration of data packets being sent without forecasting future traffic, it may be advantageous to have an alternative and preferably more accurate method for such estimations.

In light of the prior art, it is an object of the present invention to at least ameliorate one or more of the disadvantages and shortcomings of the prior art, or at least provide the public with a useful alternative. Further objects will be evident from the following description.

### SUMMARY OF THE INVENTION

In one form, although it need not be the only, or indeed the broadest form, the invention resides in a method of transmitting data packets between a first node coupled to be in communication with a first network and a second node coupled to be in communication with a second network, the first network and the second network coupled to be in communication with a plurality of network interfaces, the method including:

measuring a forward data flow rate and a reverse data flow rate between the first node and the second node;

determining an aggregate data flow rate based on the forward flow rate and the reverse flow rate; and

assigning a data flow to one or more of the network interfaces based on an available bandwidth of each network interface and the aggregate data flow rate.

Preferably, the data flow is one or more of the following: the forward data flow; the reverse data flow; a new data flow.

The method may further include assigning the forward data flow, the reverse data flow and the new data flow to be performed in accordance with a predetermined optimisation algorithm.

Preferably, the optimisation algorithm is configured to assign data flow to one or more interfaces to optimise at least one of: cost of transmission; quality of transmission; speed of transmission.

The method may further include classifying each data packet type received at a management module as either a forward data flow, a reverse data flow or a new data flow.

Preferably, the management module is located in first network and is coupled to be in communication with each network interface.

Preferably, the first network is a private network and the second network is the Internet.

The method may further include assigning a data flow identifier for each forward data flow, reverse data flow and new data flow received at the management module.

Preferably, the data flow identifier is based on one or more of the following parameters: an IP address of a data packet source; an IP address of a data packet destination; a port address of a data packet source; a port address of a data packet destination; a data packet protocol ID.

The method may further include assigning one or more token buffers for each network interface.

Preferably, each token buffer has one or more tokens which represent the available bandwidth for a respective interface.

The method may further include estimating the bandwidth of either the forward or reverse flows on the basis of one or more of the following parameters:

a size of one or more data packets;

a transmission frequency of data packets belonging to the data flow component;

the total amount of data transmitted that belongs to the data flow component;

the amount of data transmitted in a predetermined time period that belongs to the data flow component;

a total number of data packets belonging to the data flow component that have been transmitted;

a number of data packets transmitted that belong to the data flow component;

an average size of a data packet belonging to the data flow component.

The method may include determining whether a data packet received at one of the network interfaces belongs to a known data flow; and in the event that the received data packet belongs to an unknown data flow,

making an initial estimate of the flow's forward and reverse bandwidth; and

forwarding the data packet via one of the network interfaces on the basis of the estimated forward and reverse bandwidth of the data flow.

In another form, the invention resides in a method of assigning a bi-directional data flow to one of the plurality of network interfaces on the basis of estimated forward and reverse bandwidth requirement of the data flow.

In another form, the invention resides in a communication system, comprising:

a first network having a first node and a management module;

a second network having a second node; and

a plurality of network interfaces coupled to be in communication with the first network and the second network;

wherein the management module determines an aggregate data flow rate between the first node and the second node and assigns a data flow to one or more network interfaces based on the aggregate data flow rate and available bandwidth of each network interface.

In another form, the invention resides in a device for routing data packets between a first node coupled to be in communication with a first network and a second node coupled to be in communication with a second network, the first network and the second network coupled to be in communication with a plurality of network interfaces, the device comprising:

computer readable program code components configured to cause measuring a forward data flow rate and a reverse data flow rate between the first node and the second node;

computer readable program code components configured to cause determining an aggregate data flow rate based on the forward flow rate and the reverse flow rate; and

computer readable program code components configured to cause assigning a data flow to one or more of the network interfaces based on an available bandwidth of each network interface and the aggregate data flow rate.

### BRIEF DESCRIPTION OF THE DRAWINGS

In order that the present invention may be readily understood and put into practical effect, reference will now be made to the accompanying illustrations wherein:

FIG. 1 is a schematic plan of a communication system including a private network according to one embodiment of the invention;

FIG. 2 depicts data flow fields stored in a flow tracker according to another embodiment of the invention; and

FIG. 3 is a flowchart illustrating a process for routing data packets implemented in the network of FIG. 1.

### DETAILED DESCRIPTION OF THE DRAWINGS

It will be appreciated that embodiments of the invention herein described may be comprised of one or more conventional processors and unique stored program instructions that control the one or more processors to implement, in conjunction with certain non-processor circuits, some, most, or all of the functions of transmitting data packets in communication networks as herein described. Furthermore, it is expected that one of ordinary skill in the art, when guided by the disclosure herein, will be readily capable of generating such software instructions, programs and integrated circuits with minimal experimentation.

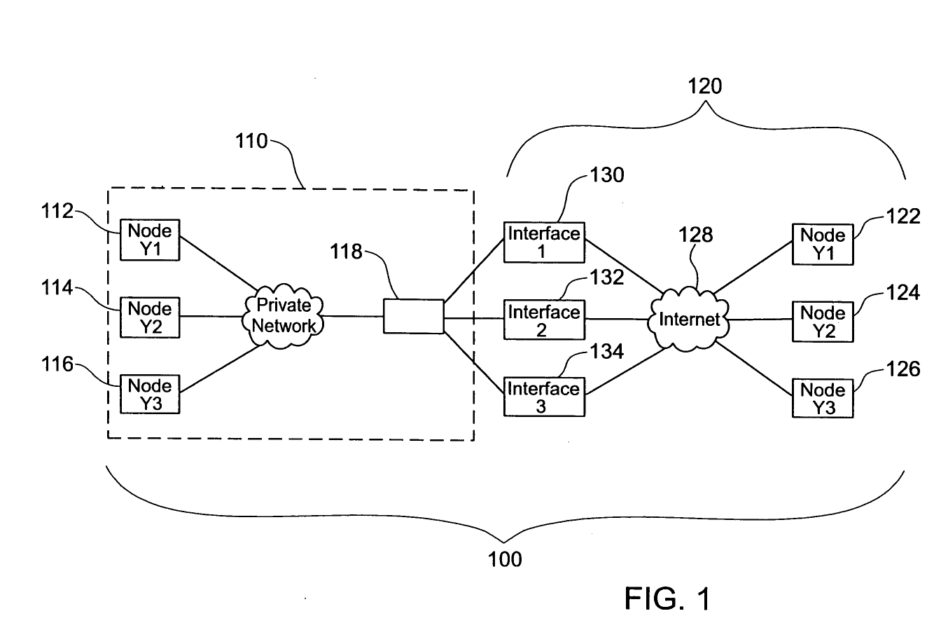

FIG. 1 illustrates communication system 100 according to an embodiment of the invention. The communication system 100 comprises a first network 110 and a second network 120. According to the embodiment shown, the first network 110 is in the form of a private network and the second network is in the form of the Internet 128. Other types of networks combinations are envisaged.

The private network 110 shown in FIG. 1 includes a number of private network nodes 112, 114 and 116. In addition to traditional network hardware and software components (not shown), the private network 110 also includes a management module 118 in the form of Routing Management Application (RMA) module. The external network 120 includes a number of external network nodes 122, 124 and 126 and a plurality of network interfaces 130, 132 and 134, which are all connected to the Internet 128. Each node on the private network 110 can connect to the Internet 128, and is therefore connectable to each node 122, 124, 126 on the Internet 102, through anyone of the network interfaces 130, 132 and 134.

All data packets being sent from a private network node 112, 114 or 116 (i.e. emanating packets) inside the private network 110 to an external network node 116, 118 or 120 must be routed through one of the network interfaces 130, 132 or 134. For the purposes of the preferred embodiment, it will be presumed that any external network node 122, 124 and 126 may be reached through any one of the network interfaces 130, 132 and 134. The decision of which network interface 130, 132 and 134 is used to route a data packet through is independent of the destination of that data packet. Any data packets being sent from an external network node 122, 124 and 126 into the private network 110 (i.e. terminating packets) must enter the private network 110 through one of the network interfaces 130, 132 and 134.

Since the private network 110 possesses links to each network interface 130, 132 and 134, it has the ability to manage how data packets are routed through the network interfaces 130, 132 and 134. The decision regarding how a particular data packet should be routed is dependent on many factors such as the cost of using each network interface, the available bandwidth of each interface and/or the quality of service and data transfer speed provided by each interface. As those skilled in the art can appreciate, these factors and other factors may influence a routing decision in the communication network 100. In order to manage the routing of data packets, the management module 118 is provided.

The management module 118 intercepts, analyses and routes all data packets emanating from the private network 110 to one of the available network interfaces 130, 132 or 134. Similarly, all terminating data packets entering the private network 110 through one of the network interfaces 130, 132 or 134 are intercepted by the management module 118 for analysis prior to being forwarded to the final destination (i.e. external network nodes 122, 124 or 126). The management module 118 functions to implement flow tracking, bandwidth management, flow based routing strategies, failover, and capacity discovery, each of which will be described in detail below.

For the purpose of the discussion of the preferred embodiment, data packets will be deemed to be either emanating or terminating. Emanating data packets are sent from a source (private network nodes 112, 114 or 116) on the private network 110 to a destination (external network nodes 122, 124 or 126) on the Internet 102. In the preferred embodiment, emanating data packets are sent from a source (e.g. node 112) and intercepted by the management module 118 before being forwarded to a network interface 104, 106 or 108 for routing to a destination (e.g. node 122).

Terminating data packets are sent from a source (external network nodes 122, 124 or 126) on the Internet 128 to a destination (private network nodes 112, 114 or 116) on the private network 110. In the preferred embodiment, terminating data packets are received by one of the network interfaces 130, 132 or 134 and are passed to the management module 118 before being forward to a destination (e.g. node 112) on the private network 110.

In the examples described below, data packets being transmitted between two network nodes, private network node 112 and external network node 122, will be discussed.

In this case:
node 112 is deemed to have an address of ‘x’ and node 122 is deemed to have an address of ‘y’. Emanating data packets will therefore have a source address x and a destination address y; and
terminating data packets will have a source address y and a destination address x.

The full source and destination information of a data packet can additionally include information such as an IP address, a port address and/or a protocol identifier.

According to some embodiments of the invention, the management module 118 comprises computer readable program code components configured to cause measuring a forward data flow rate and a reverse data flow rate between network node 112 and network node 122. The management module 118 can include computer readable program code components configured to cause determining an aggregate data flow rate based on the forward flow rate and the reverse flow rate. In addition, the management module 118 can include computer readable program code components configured to cause assigning a data flow to one or more of the network interfaces 130, 132, 134 based on an available bandwidth of each network interface and the aggregate data flow rate. In alternative embodiments, the aforementioned functionality can be implemented in hardware.

Data Flows

The management module 118 relies on the concept of data flows to analyse network traffic. Traditionally, data flows are considered to be the aggregate of data packets being sent from the same source to the same destination. Although this traditional approach is useful, it only provides a partial picture of data communication in a data packet switched environment.

In the majority of cases, data packet switched communication involves information being transmitted in two directions. Information is sent from a source x to a destination y (emanating data) and in response to that information the destination y sends information back to the original source x (terminating data). This response information may simply be acknowledgment data. Alternatively, the emanating data may be a request for data (such as a file, a web page, streaming audio/video) in which case a response including the requested data will be sent back to the source.

To account for this two way data flow of information, data flows in the preferred embodiment of the invention include an emanating flow component and a terminating flow component both of which are considered in making bandwidth estimations and data flow routing decisions. The emanating flow component includes all data packets being sent from source (node 112) to destination (node 122), and the terminating flow component includes all data packets being sent back to the source (node 112) from destination (node 122). The emanating flow, for example, may comprise data packets sent from source (node 112) requesting information from destination (node 122). In this case, the terminating flow is the data packets being sent from node 122 back to node 112, in response to the initial request from node 112.

In order to identify different data flows and to associate a particular data packet with a particular data flow, when the management 118 receives a data packet and calculates a hash value based on the source and destination information contained in the data packet. The calculated hash value becomes the data flow identifier and all data packets with the same calculated hash value are deemed to belong to the same data flow. If the hash value is not collision free, a sub identifier may be necessary as part of the data flow identifier to account for cases where two or more different flows result in the same calculated hash value.

The management module 118 analyses all data packets, either emanating or terminating and, for each data packet calculates a data flow identifier to determine whether the packet belongs to an existing data flow or a new data flow. The data flow identifier of an emanating packet is calculated by the hash value of the data packet's source address (node 112) and destination address (node 118). The data flow identifier of a terminating packet is calculated by the hash value of the data packet's destination address (node 112) and source address (node 118). By switching the order of the source address and the destination address for the terminating data packets, the hash value for emanating data packets and terminating data packets are the same, thus indicating they are part of the same data flow.

The information defining the ‘source’ and ‘destination’ addresses of data packets may be decided on the level of traffic and/or control requirements. For example, if traffic details and/or control are required, the hash values may be calculated on IP addresses only. In this case each data flow will be relatively large, denoting all data packets being sent from the IP address of node 112 to the IP address of node 122 and all packets from the IP address of node 122 to the IP address of node 112.

Preferably the hash value is calculated on the IP address, the port address and the protocol identifier (e.g. an identifier denoting the file transfer protocol). In this case, each data flow will be relatively smaller, consisting only of those data packets of the same protocol being sent from a particular port on the source IP address of node 112 to a particular destination port on the destination IP address of node 122 and, packets from a particular source port on the source IP address of node 122 to a particular destination port on the destination IP address of node 112.

Table 1 sets out a number of exemplary hash value calculation schemes that could be implemented in embodiments of the present invention.

TABLE 1

| | Emanating flow | Terminating | |
|---|---|---|---|
| Address | ID: Hash on | flow ID: Hash on | Detail/Control |
| IP Address | source IP, | destination IP, | Low |
| | destination IP | source IP | |
| IP Address | source IP, | destination IP, | Medium |
| Port Address | destination IP, | source IP, | |
| | source port, | destination port, | |
| | destination port | source port, | |
| IP Address | source IP, | destination IP, | High |
| Port Address | destination IP, | source IP, | |
| Protocol ID | source port, | destination port, | |
| | destination port, | source port, | |
| | protocol ID | protocol ID | |

In an alternative but less effective embodiment, flow identifiers of emanating (i.e. forward) and terminating (i.e. reverse) data flow components need not be calculated to be the same (i.e. the flow identifier for the emanating packets is calculated by a hash over the packet's source address, and destination address, and the flow identifier for the terminating packets is calculated as a hash over the packet's source address and destination address). In this way, the flow identifier of the emanating packets travelling from node 112 to node 122 will be different to the flow identifier of the terminating packets travelling from node 122 to node 112.

If this is the case, the forward and reverse data flows may be associated with each other in a list or table so the management module 118 can recognise they are part of the same data flow, or may even be considered and managed as distinct data flows by the management module 118. If they are managed separately, important information such as the amount of data being sent back into the private network 110 as a result of a particular forward data flow is lost. If the forward and reverse data flow components are associated with each other at a later stage (e.g. by associating the data flows in a secondary list or table), greater computational and memory overhead are introduced.

In a still further embodiment, an estimate of the size of the reverse data flow may be made by analysis of the forward data flow component (e.g., by analysis of the protocol of the forward data flow component). For example, if the forward flow data packet is a request for a web page, it is likely to require far less traffic for the corresponding reverse data flow than if the forward flow data packets are requesting streaming video.

Tokens and Token Handling

In order to efficiently monitor and manage bandwidth on the available network interfaces 130, 132 and 134 and make routing decisions, the management module 118 maintains at least one (preferably more than one) token buffer for each of the network interfaces 130, 132 and 134. Tokens effectively represent a unit of bandwidth, each token accounting for a fraction of the network interface's transmission rate. For example, a network interface may have an estimated total transmission capacity of 100 kilobytes per second, and a single token may represent 1 kilobyte per second. In this case, the token buffer for the network interface would have 100 tokens representing the entire bandwidth capacity of the network interface.

Where a network interface has dedicated outgoing and incoming bandwidth (i.e. a full duplex connection), forward and reverse token buffers are preferably maintained. If the connection is half duplex, (i.e. data may only be sent or received at any given time) a single token buffer may be used. The number of token buffers used may also be determined on the basis of how bandwidth allowances are calculated by the ISP (or other entity) to which the interface is connected. If for example, bandwidth limits for incoming and outgoing data are set independently of each other then it is preferable to use a dedicated token buffer for each direction of data flow. However, if the total bandwidth assigned to the network interface is fixed, but the relative allocation to forward and reverse flow components can be varied then it may be preferable to use a single shared token buffer to manage bandwidth usage in both directions.

In general terms, a token buffer for a network interface has tokens removed from it or added to it to account for fluctuations, in the amount of bandwidth being used by the data flows being routed through the network interface. An entirely unused network interface will have a completely full token buffer and a network interface for which all available bandwidth has been assigned to one or more flows will have a completely empty token buffer. In use, tokens are removed from a token buffer and assigned to data flows as they are assigned to the network interface or if they increase or decrease in size and tokens are returned to the token buffer if a flow stops (e.g. is timed out) or reduces in size.

As data flows are added to and removed from a network interface, the token buffer associated with that network interface is updated accordingly. For example, in a case with dedicated forward and reverse token buffers, if a new data flow arrives on a particular network interface, an initial number of tokens are reserved for each of the forward and reverse flow components. From time to time the size of the forward and reverse data flow components will be estimated and, if the flow turns out to be larger than the initial estimate in either direction, further tokens are assigned to that data flow component, reducing the number of tokens available for that interface in the direction. Conversely if a data flow component is smaller than expected then the number of tokens assigned to a flow component can be reduced. When the flow finishes, all tokens associated with the flow are returned to the token buffer.

In order to monitor the size and continuity of flows or flow components the management module 118 maintains a flow tracker as described below.

Flow Tracker and Flow Tracking

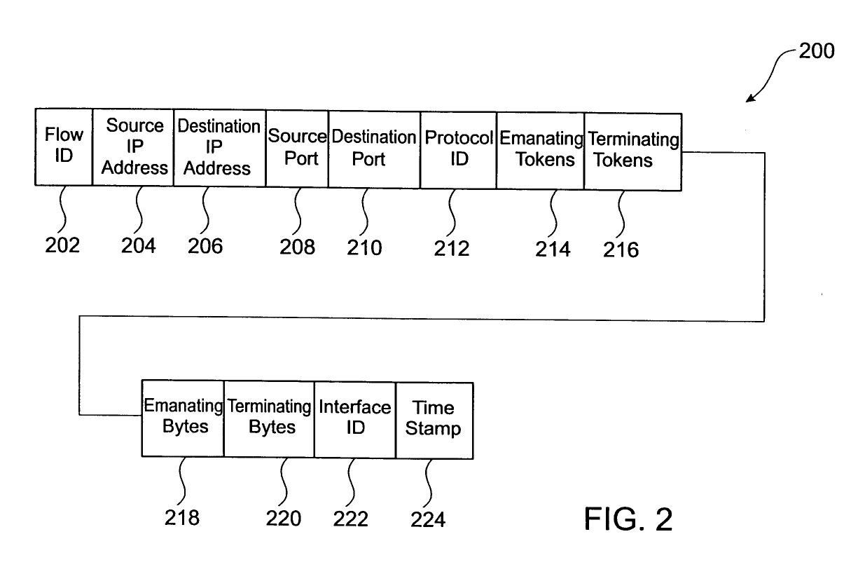

The management module 118 maintains a flow tracker comprising a hash-based data structure in which flow state information is stored. FIG. 2 provides a representation of the data structure 200 of the information fields of the flow tracker according to an embodiment of the invention. The index of the data structure is the hash value of the flow identifier 202. Each individual data flow may include a data structure that stores the flow identifier 202, a source IP address 204, a destination IP address 206, a source port 208, a destination port 210, a protocol ID 212, emanating tokens 214, terminating tokens 216, emanating bytes 218, terminating bytes 220, interface ID 222 and time stamp 224.

The time stamp 224 provides information regarding the last time a data packet associated with that flow was received at the management module. A “time to live” may be set in the management module 118, and if the time stamp 224 indicates that the flow is older than the “time to live” (i.e. no data packets for that data flow have been received at the management module within the selected time), the entry in the flow tracker relating to that flow is deleted. When a data packet is received by the management module and is associated with an existing data flow, the time stamp 224 corresponding to the flow identifier 202 of the packet is updated.

In order to delete flows that are no longer active, the flow tracker may order flows according to the time stamp 224. When a data packet is received which is part of an existing data flow and the time stamp 224 for that data flow is updated, the position of that data flow in the flow tracker may be moved to the front of the list. This provides for the efficient management of data flows in that old data flows can simply be deleted from the tail of the list and additional processing is avoided.

The emanating tokens field 214 and terminating tokens field 216 store the number of flow tokens currently assigned to the emanating and terminating flow components respectively. This is discussed in greater detail below in the Token Handling section.

The emanating bytes field 218 and terminating bytes field 220 store information detailing the aggregate number of bytes sent and received in the emanating and terminating components of the data flow respectively.

The interface ID field 222 refers to the particular network interface through which data packets are routed through.

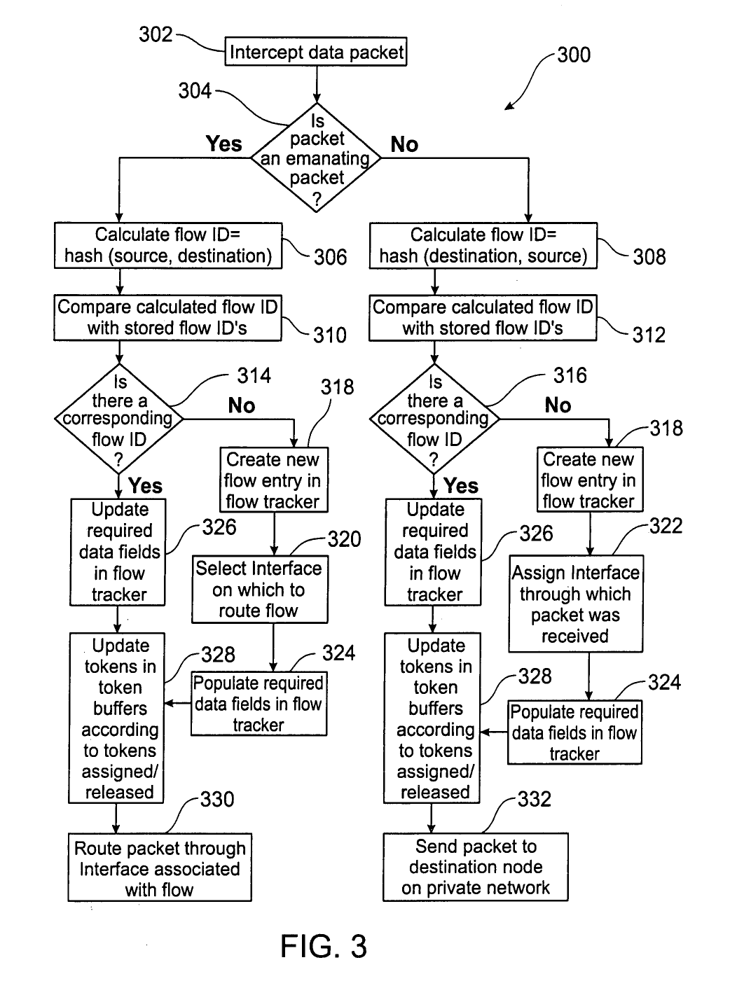

FIG. 3 depicts the process 300 by which the management module maintains flow information in the flow tracker according to another embodiment of the invention.

The management module intercepts 302 all data packets being sent from or to the private network 110 (i.e. all emanating and terminating data packets). Each data packet is detected 304 to be either an emanating data packet or a terminating data packet.

If the data packet is determined to be an emanating data packet (e.g. if the source address of the data packet is an address on the private network 110) the management module 118 calculates a data flow identifier 306 for the packet as:
hash (source IP address, destination IP address, source port, destination port, protocol ID).

If the data packet is determined to be a terminating data packet at 304 (e.g. if the source address of the data packet is an address outside the private network 110) the management module 118 calculates the data flow identifier 308 for the packet as:
hash (destination IP address, source IP address, destination port, source port, protocol ID).

In this way emanating and terminating data packets that belong to the same communication flow are associated to the same data flow and same entry in the data structure.

Ideally, a non-colliding hash function is used to calculate the data flow identifiers, ensuring that each data flow is assigned a unique flow identifier. However, if the hash function is used to calculate an identical data flow identifier (i.e. the hash value calculated for two packets belonging to separate flows may end up the same), data collisions can be resolved in a secondary data structure such as a linked list.

Once the data flow identifier for a data packet has been calculated, the management module 118 compares the calculated data flow identifier with flow identifiers stored in the flow tracker 310 and 312 to determine whether the data packet is part of an existing data flow or a new data flow 314 and 316. If the calculated data flow identifier of the data packet occurs in the flow tracker the data packet forms part of an existing data flow. If the calculated data flow identifier of the packet does not occur in the flow tracker the data packet is part of a new data flow.

New Flow

If the packet belongs to a new flow, a new entry for that flow identifier is created and stored 318 in the flow tracker.

If the packet is an emanating packet the interface 10 for that flow is determined 320 according to the network interface assignment or routing strategy as discussed below. If the packet is a terminating packet, the network interface for that flow is assigned 322 to the network interface through which the packet was received.

The management module 118 then populates the data fields 324 in the flow tracker corresponding to the new flow. The source and destination IP address fields and source and destination port address fields are populated according to the corresponding information in the data packet (again, noting that if the data packet is a terminating packet the source and destination addresses must be switched). The time stamp associated with the flow is also updated according to the time the data packet was received.

The number of tokens assigned to the flow components is determined as discussed below in relation to token handling, and the emanating and terminating token fields are populated.

If the packet is an emanating packet the emanating bytes field is updated according to the size of the data packet (the terminating bytes field left at zero), and if the data packet is a terminating data packet the terminating bytes field is updated according to the size of the data packet (the emanating bytes field left at zero).

Existing Flow

If the calculated flow identifier corresponds to a flow identifier existing in the flow tracker, the packet is deemed to be part of an existing flow. In this case the flow ID, source IP, destination IP, source port, destination port and interface ID fields are already known and stored in the flow tracker and do not need to be updated.

The management module 118 does, however, update 326 the appropriate data fields to maintain up to date information on flow statistics.

If the packet is an emanating packet, the emanating bytes field is updated to be the existing value for that field plus the size of the packet and the terminating bytes field remains unchanged.

If the packet is a terminating packet, the terminating bytes field is updated to be the existing value of that field plus the size of the packet, and the emanating bytes field remains unchanged.

The time stamp field is also updated to the time the packet was received.

From time to time, and preferably upon receipt of every new data packet, the size of the flow component (or flow) is estimated and the number of tokens assigned to the flow component (or flow) from its corresponding interfaces token buffer is recalculated. Upon recalculation of the number of tokens assigned to a flow, the flow tracker data fields 214 and 216 relating to the assigned number of emanating tokens and terminating tokens respectively are updated.

Table 2 below summarises the update actions required for the flow tracker data structure in the event of a packet being received.

TABLE 2

| | Packet corresponds to: | | | |
|---|---|---|---|---|
| | New | New | Existing | Existing |
| Flow tracker | emanating | terminating | emanating | terminating |
| field | flow | flow | flow | flow |
| Flow ID | Calculating | Calculating | Packet details correspond | |
| | flow ID | flow ID | to exiting flow in | |
| Source IP | Source IP of | Destination | flow tracker: | |
| | packet | IP of packet | No update required | |
| Destination | Destination | Source IP of | | |
| IP | IP of packet | packet | | |
| Source Port | Source port | Destination | | |
| | of packet | port of packet | | |
| Destination | Destination | Source port | | |
| Port | port of packet | of packet | | |
| Emanating | Assign as per | Assign as per | Update | Does not |
| Tokens | policy | policy | | change |
| Terminating | Assign as per | Assign as per | Does not | Update |
| Tokens | policy | policy | change | |
| Emanating | Size of | 0 | Old | Does not |
| bytes | packet | | value + | change |
| | | | size of | |
| | | | packet | |
| Terminating | 0 | Size of | Does not | Old value + |
| bytes | | packet | change | size of |
| | | | | packet |
| Interface ID | Selected | ID of | Already populated as is | |
| | interface ID | interface | existing flow | |
| | | through | | |
| | | which packet | | |
| | | arrived | | |
| Time Stamp | Time of | Time of | Time of | Time of |
| | packet arrival | packet arrival | packet | packet |
| | | | arrival | arrival |

Further manipulation of the data fields in the flow tracker will be discussed below in relation to failover scenarios.

From time to time, and preferably after every packet is received, the management module updates the token buffer information 328 as discussed above. If the packet is an emanating packet, the management module 118 then routes 330 the packet through the interface associated through the flow the packet is part of. If the packet is a terminating packet the management module routes 332 the packet to the destination node on the private network.

Routing Strategies

Routing strategies for emanating data packets (and flows) may be implemented according to the way tokens are assigned to new flows. Forwarding preferences may depend on a number of factors, such as cost, performance, best practice requirements or service types, and strategies may be changed dynamically depending on external factors such as the time of day or traffic thresholds.

Overflow Routing

Overflow routing is a strategy that is useful in the case where some interfaces are preferable over others—for example one interface is cheaper than the other interfaces and therefore preferable.

In this scenario one path (for example, the cheapest path) is designated to be the default path and is the first choice for routing new flows. If that path becomes ‘full’—i.e. estimations indicate that no bandwidth is available in either the forward or reverse direction, the new flow is routed to the next preferred interface and so on.

For such a routing scheme when a packet belonging to a new flow arrives, the management module 118 checks the default interface and if sufficient tokens are available for both directions on that interface, it assigns the new flow to that interface (and reduces the tokens in the token buffer(s) accordingly). If, when the default interface is checked, no tokens are available, the next preferred interface is checked for available tokens and, if tokens are available, the flow is assigned to that interface.

Accurate Load Balancing

If there are no inherent reasons why a particular interface should be preferred over another (e.g. the costs and other overheads associated with all interfaces are the same), the chosen routing strategy may be to distribute traffic evenly between the available interfaces.

This even distribution may be achieved in a number of ways, the simplest of which being when a packet belonging to a new flow arrives, the available tokens on each interface are checked and the flow is routed to the interface having (nominally or proportionally) the most available tokens. Alternatively the new flow can be routed to the interface which results in the most evenly distributed “interface utilization” across all the possible interfaces. In this case the interface utilization is calculated by:

Tokens used/total possible tokens for interface.

Failover

In the case of one or more interfaces failing, traffic on failed links must be rerouted. The failing of an interface may be detected by the operating system and signalled to the management module. Where such a signal is received the management module 118 reduces the number of available tokens for the failed interface(s) to zero and flushes all the flow trackers for flows on that link.

Once the flows are flushed, the next packet for that flow arriving at the management module is not recognised as a packet for an existing flow and is routed as if it is a packet belonging to a new flow.

In this manner only flows that were assigned to the failed interface(s) are impacted, with all other flows remaining on their assigned interfaces.

Although in the preferred embodiment the routing distribution application and all above functionality is described as a single application it is, of course, possible to distribute the functionality between any number of applications and/or physical devices.

Throughout the description and claims of this specification, the word “comprise” and variations of that word such as “comprises” and “comprising”, are not intended to exclude other additives, components, integers or steps. Throughout the specification the aim has been to describe the invention without limiting the invention to any one embodiment or specific collection of features. Persons skilled in the relevant art may realize variations from the specific embodiments that will nonetheless fall within the scope of the invention.

1. A method of transmitting data packets between a first node coupled to be in communication with a first network and a second node coupled to be in communication with a second network, the first network and the second network coupled to be in communication with a plurality of network interfaces, the method including:
measuring a forward data flow rate and a reverse data flow rate between the first node and the second node;
determining an aggregate data flow rate based on the forward flow rate and the reverse flow rate; and
assigning a data flow to one or more of the network interfaces based on an available bandwidth of each network interface and the aggregate data flow rate.

2. The method as recited in claim 1, wherein the data flow is one or more of the following: the forward data flow; the reverse data flow; a new data flow.

3. The method as recited in claim 2, wherein assigning the forward data flow, the reverse data flow and the new data flow is performed in accordance with a predetermined optimisation algorithm.

4. A method as recited in claim 3, wherein the optimisation algorithm is configured to assign data flow to one or more interfaces to optimise at least one of: cost of transmission; quality of transmission; speed of transmission.

5. The method as recited in claim 1, further including:
classifying each data packet type received at a management module as either a forward data flow, a reverse data flow or a new data flow.

6. The method as recited in claim 5, wherein the management module is located in first network and is coupled to be in communication with each network interface.

7. The method as recited in claim 1, wherein the first network is a private network and the second network is the Internet.

8. The method as recited in claim 1, further including:
assigning a data flow identifier for each forward data flow, reverse data flow and new data flow received at the management module.

9. The method as recited in claim 8, wherein the data flow identifier is based on one or more of the following parameters: an IP address of a data packet source; an IP address of a data packet destination; a port address of a data packet source; a port address of a data packet destination; a data packet protocol ID.

10. The method as recited in claim 1, further including:
assigning one or more token buffers for each network interface.

11. The method as recited in claim 10, wherein each token buffer has one or more tokens which represent the available bandwidth for a respective interface.

12. A communication system, comprising:
a first network having a first node and a management module;
a second network having a second node; and
a plurality of network interfaces coupled to be in communication with the first network and the second network;
wherein the management module determines an aggregate data flow rate between the first node and the second node and assigns a data flow to one or more network interfaces based on the aggregate data flow rate and available bandwidth of each network interface.

13. The communication system as recited in claim 12, wherein the data flow is one or more of the following: a forward data flow; a reverse data flow; a new data flow.

14. The communication system as recited in claim 12, wherein the management module is configured to assign the data flow to one or more network interfaces in accordance with a predetermined optimization algorithm.

15. The communication system as recited in claim 14, wherein the optimisation algorithm assigns data flow to one or more network interfaces to optimise at least one of: cost of transmission; quality of transmission; speed of transmission.

16. The communication system as recited in claim 12, wherein the management module is configured to classify each data packet received as either a forward data flow, a reverse data flow or a new data flow.

17. The communication system as recited in claim 12, wherein the first network is a private network and the second network is the Internet.

18. The communication system as recited in claim 13, wherein the management module is configured to assign a data flow identifier for each forward data flow, reverse data flow and new data flow received.

19. The communication system as recited in claim 18, wherein the data flow identifier is based on one or more of the following parameters: an IP address of a data packet source; an IP address of a data packet destination; a port address of a data packet source; a port address of a data packet destination; a data packet protocol ID.

20. The communication system as recited in claim 18, wherein the management module is configured to designate common data flow identifiers for a forward data flow and a reverse data flow as a common flow path.

21. The communication system as recited in claim 12, wherein the management module is configured to assign one common flow path to one or more network interfaces.

22. The communication system as recited in claim 12, wherein the management module is configured assign one or more token buffers for each network interface.

23. The communication system as recited in claim 22, wherein each token buffer has one or more tokens which represent the available bandwidth for a respective interface.

24. A device for routing data packets between a first node coupled to be in communication with a first network and a second node coupled to be in communication with a second network, the first network and the second network coupled to be in communication with a plurality of network interfaces, the device comprising:
computer readable program code components configured to cause measuring a forward data flow rate and a reverse data flow rate between the first node and the second node;
computer readable program code components configured to cause determining an aggregate data flow rate based on the forward flow rate and the reverse flow rate; and
computer readable program code components configured to cause assigning a data flow to one or more of the network interfaces based on an available bandwidth of each network interface and the aggregate data flow rate.

25. The device as recited in claim 24, wherein the data flow is one or more of the following: the forward data flow; the reverse data flow; a new data flow.

26. The device as recited in claim 25, further including:
computer readable program code components configured to cause assignment of the forward data flow, the reverse data flow and the new data flow to be performed in accordance with a predetermined optimisation algorithm.

27. The device as recited in claim 26, wherein the optimisation algorithm is configured to assign data flow to one or more interfaces to optimise at least one of: cost of transmission; quality of transmission; speed of transmission.

28. The device as recited in claim 25, further including:
computer readable program code components configured to cause classification of each data packet type received at the device as either a forward data flow, a reverse data flow or a new data flow.

29. The device as recited in claim 24, wherein the device is located in the first network and is coupled to be in communication with each network interface.

30. The device as recited in claim 24, wherein the first network is a private network and the second network is the Internet.

31. The device as recited in claim 24, further including:
computer readable program code components configured to cause assignment of a data flow identifier for each forward data flow, reverse data flow and new data flow received.

32. The device as recited in claim 31, wherein the data flow identifier is based on one or more of the following parameters: an IP address of a data packet source; an IP address of a data packet destination; a port address of a data packet source; a port address of a data packet destination; a data packet protocol ID.

33. The device as recited in claim 31, further including:
computer readable program code components configured to cause designation of common data flow identifiers for a forward data flow and a reverse data flow as a common flow path.

34. The device as recited in claim 24, further including:
computer readable program code components configured to cause assignment of one or more token buffers for each network interface.

35. The device as recited in claim 34, wherein each token buffer has one or more tokens which represent the available bandwidth for a respective interface.
